(19) United States
(12) Patent Application Publication
(10) Pub. No.: US 2019/0227696 A1
(43) Pub. Date: Jul. 25, 2019

(54) COMPUTER IMPLEMENTED METHOD AND SYSTEM FOR ACCESSING CONTENT OF DIGITAL PAGES

(71) Applicant: RAVI GULLAPALLI, Southlake, TX (US)

(72) Inventor: RAVI GULLAPALLI, Southlake, TX (US)

(21) Appl. No.: 15/876,102

(22) Filed: Jan. 19, 2018

(51) Int. Cl. G06F 3/0481; G06F 3/0484

(52) U.S. Cl. CPC G06F 3/04817; G06F 3/04845; G06F 3/04842

(57) ABSTRACT

Exemplary embodiments of the present disclosure are directed towards a computer implemented method and system for accessing content of digital pages. The method comprising a step of selecting a digital page by a user and displaying a digital content on the selected digital page, enabling the user to perform a first plurality of predefined actions on the digital content on the selected digital page, orienting the digital page for displaying a supplemental digital content on the oriented digital image and enabling the user to perform a second plurality of predefined actions on the supplemental digital content on the oriented digital page.

### TECHNICAL FIELD

The disclosed subject matter relates generally to accessing digital pages in computing devices. More particularly, the present disclosure relates to a computer implemented method and system for accessing content of digital pages.

### BACKGROUND

The continued proliferation of digital content has led to an increase in the availability of different formats and types of digital content. Also a simultaneous increase in the usage of computing devices has made easy to access the digital content. For instance, the usage of computing devices to view digital books, videos, songs, documents, webpages, images, applications is becoming interesting and engaging by enhancing the content accessing experience.

In some instances it may be required to add supplemental digital content to the original digital content. Conventional methods include adding the supplemental content at the bottom position or towards any side portion of the original digital content or by scrolling the digital content. This results in disturbing the viewing experience and may also not provide pleasant view of the original digital content. The user would generally prefer a user interface which enables the user to efficiently and intuitively access such information.

In the light of aforementioned discussion, there exists a need for certain system with a novel methodology that would overcome the above-mentioned disadvantages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards enabling an orientation of digital pages to incorporate and access supplemental digital content. For instance the digital page, here, may be referred to a page accessed through a web browser, or through a mobile application. Here the digital page may be of different formats, including, but not limited to, a text web-page, video page, image page, multimedia page, different file formats accessible through online or offline applications. The image and video formats may include but not limited to MPO, PNS, JPS, ANI, ANIM, APNG, ART, BMP, BPG, BSAVE, CAL, CIN, CPC, CPT, DDS, DPX, ECW, EXR, FITS, FLIC, FLIF, FPX, GIF, HDRi, HEVC, ICER, ICNS, ICO/CUR, ICS, ILBM, JBIG, JBIG2, JNG, JPEG, JPEG 2000, JPEG-LS, JPEG XR, KRA, MNG, MIFF, NRRD, ORA, PAM, PBM, PGM, PPM, PNM, PCX, PGF, PICtor, PNG, PSD, PSB, PSP, QTVR, RAS, RBE, JPEG-HDR, Logluv, TIFF, SGI, TGA, TIFF, TIFF/EP, TIFF/IT, UFO/ UFP, WBMP, WebP, XBM, XCF, XPM, XWD, CIFF, DNG, AI, CDR, CGM, DXF, EVA, EMF, Gerber HVIF, IGES, PGML, SVG, VML, WMF, Xar, CDF, DjVu, EPS, PDF, PICT, PS, SWF, XAML, Exif, XMP, not just limited to the standard but also in any format or size which is custom made and known in the art or implemented in the future. The video formats may include but not limited to .webm (Matroska), .mkv (Matroska), .flv (FLU), .flv (MPEG-4 Part 12), .vob (VOB), .ogv, .ogg (OGG), .drc, .gif, .gifv, .mng, .avi, .mov, .qt (Quick Time), .wmv (ASF), .yuv, .rm (RealMedia), .rmvb (RealMedia Variable Bitrate), .asf, .amv (AVI 4), .mp4, .m4p (with DRM), .m4v (H.264, MPEG-4 Part 12), .mpg, .mp2, .mpeg, .mpe, .mpv (MPEG-1), .mpg, .mpeg, .m2v, .m4v, .svi, .3gp (MPEG-4), .3g2 (MPEG-4), .mxf, .roq, .nsv not just limited to the standard but also in any format or size which is custom made and known in the art or implemented in the future.

Another objective of the present disclosure is directed towards creating additional space to display the digital content on digital pages by orientation (here orient may be referred to flip, rotate, tilt or any other similar action performed on the digital page) of digital pages.

Another objective of the present disclosure is directed towards enabling the user to view the supplemental digital content by orienting the digital page without any distraction and sharing the digital content along with digital content owner information.

Another objective of the present disclosure is directed towards displaying the supplemental digital content after orientation of the digital page. The supplemental digital content may include, but not limited to, an advertisement, the owner information, a page information, and the like.

Another objective of the present disclosure is directed towards generating revenue source in response to displaying the supplemental digital content. The revenue source can be a direct revenue or an indirect revenue.

Another objective of the present disclosure is directed towards giving importance to the user visibility of the digital content and allowing the user to remove selected digital content on the digital pages.

Another objective of the present disclosure is directed towards advertising the digital content associated with a product.

In an embodiment of the present disclosure, a method comprises selecting a digital page by a user and displaying a digital content on the selected digital page.

In another embodiment of the present disclosure, the method comprises enabling the user to perform a first plurality of predefined actions on the digital content on the selected digital page.

In another embodiment of the present disclosure, the method comprises orienting the digital page for displaying a supplemental digital content on the oriented digital image.

In another embodiment of the present disclosure, the method comprises enabling the user to perform a second plurality of predefined actions on the supplemental digital content on the oriented digital page.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a diagram depicting an exemplary environment in which various embodiments disclosed herein may be implemented. Specifically, FIG. 1 depicts a schematic representation of environment 100 for accessing content of digital pages.

FIG. 2 is a diagram depicting a digital content accessing system 102 shown in FIG. 1, in accordance with one or more embodiments.

FIG. 3 is a flow diagram depicting a method for accessing content of digital pages, in accordance with one or more embodiments.

FIG. 4 is a flow diagram depicting a method of orienting digital pages to include a supplemental digital content, in accordance with one or more embodiments.

FIG. 5 is a flow diagram depicting a method for sharing digital content to other users, in accordance with one or more embodiments.

FIG. 6A is an example diagram depicting a digital content on the digital page, in accordance with one or more exemplary embodiments.

FIG. 6B-FIG. 6C are example diagrams depicting motion of digital pages, in accordance with one or more exemplary embodiments.

FIG. 6D is an example diagram depicting a share option on the digital page, in accordance with one or more exemplary embodiments.

FIG. 6E is an example diagram depicting number of users in the digital page, in accordance with one or more exemplary embodiments.

FIG. 6F-FIG. 6G are example diagrams depicting a real time conversation, in accordance with one or more exemplary embodiments.

FIG. 6H-6I example diagrams depicting the digital content and the supplemental digital content, in accordance with one or more exemplary embodiments.

FIG. 7 depicts a more detailed view, of the computing device shown in FIG. 1, according to one embodiment.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Referring now to the drawings wherein like numerals represent like elements throughout the several figures, FIG. 1 is a diagram depicting an exemplary environment 100 in which various embodiments disclosed herein may be implemented. Specifically, FIG. 1 depicts a schematic representation of environment 100 for accessing content of digital pages. The environment 100 may include, a digital content accessing system 102, a computing device 104, and a network 106. The computing device 104 represents a system such as personal computer, workstation, electronic book reader, personal digital assistant, mobile station, mobile phones, computing tablets, and the like. When the computing device 104 corresponds to mobile devices (e.g., mobile phones, tablets etc.), and the applications (e.g. the digital content accessing system 102) accessed are mobile applications, software that offers the functionality of accessing mobile applications, and viewing/processing of interactive pages, for example, is implemented in computing device 104 as will be apparent to one skilled in the relevant arts by reading the disclosure provided herein. The network 106 may include, but not limited to, an ethernet, a wireless local area network (WLAN), or a wide area network (WAN), a Wi-Fi communication network e.g., the wireless high-speed internet, or a combination of networks, a cellular service such as a 4G (e.g., LTE, mobile WIMAX) or 5G cellular data service. The network 106 may provide for transmission of data and/or information via a control protocol, hypertext transfer protocol, simple object access protocol or any other internet communication protocol. The digital content accessing system 102 may be accessed as a web based application or a mobile based application or a cloud server and may be configured to enable the users to access, share, and update the digital content on the digital pages. The digital content accessing system 102 may be configured to be accessed as a communication medium (for e.g., a messenger chat window, e-mail, telephone, and audio-visual) to the users. The communication medium may facilitate the transmission and reception of the digital content.

The digital content accessing system 102 may include digital pages. The digital content accessing system 102 may be configured to enable the users to enlarge and view the digital content on the digital pages. The digital content accessing system 102 may be configured to allow the digital pages to orient at a desired angle or position for viewing the pre-existing supplemental digital content or to incorporate additional supplemental digital content or incorporate desired supplemental digital content. The digital content accessing system 102 may also be configured for enabling the users to share the digital content with other users.

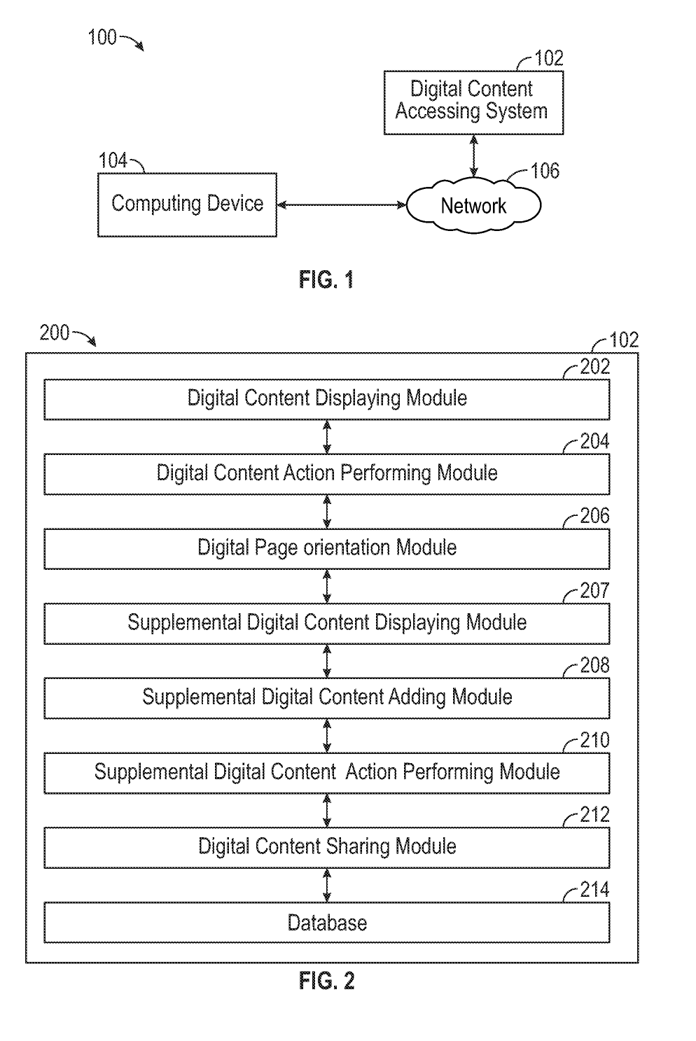

Referring to FIG. 2, FIG. 2 is a diagram 200 depicting a digital content accessing system 102 shown in FIG. 1, in accordance with one or more embodiments. The digital content accessing system 102 may be configured to access content of digital pages. The digital content accessing system 102 may further include a digital content displaying module 202, a digital content action performing module 204, a digital page orientation module 206, a supplemental digital content displaying module 207, a supplemental digital content adding module 208, a supplemental digital content action performing module 210, a digital content sharing module 212, and a database 214.

The digital content displaying module 202 may be configured to display the digital content on the digital pages. The digital content action performing module 204 may be configured to enable the user to perform a first predefined action on the digital content on the digital pages. The first predefined action may include a selection of the digital content, a long press action, and a double click action. The digital page orientation module 206 may be configured to enable the digital pages to orient for displaying the supplemental digital content. The supplemental digital content displaying module 207 may be configured to display the supplemental digital content on the oriented digital pages. The supplemental digital content adding module 208 may be configured to enable the user to add the supplemental digital content after orienting of the digital pages. The supplemental digital content action performing module 210 may be configured to enable the user to perform a second action on the supplemental digital content on the digital pages. The second action may include follow the supplemental digital content, unfollow the supplemental digital content, enable the user to perform a purchasing activity of a product associated with the supplemental digital content. The purchase action may include, but is not limited to, buying products, and selling products. For an example, the supplemental digital content action performing module 210 enables the user to unfollow or follow the supplemental digital content on the digital pages, i.e., the supplemental digital content may display or may not display on the digital pages. The digital content sharing module 212 may be configured to enable the users to share the digital content and the supplemental digital content. The database 214 may be configured to store the digital content and the supplemental digital content.

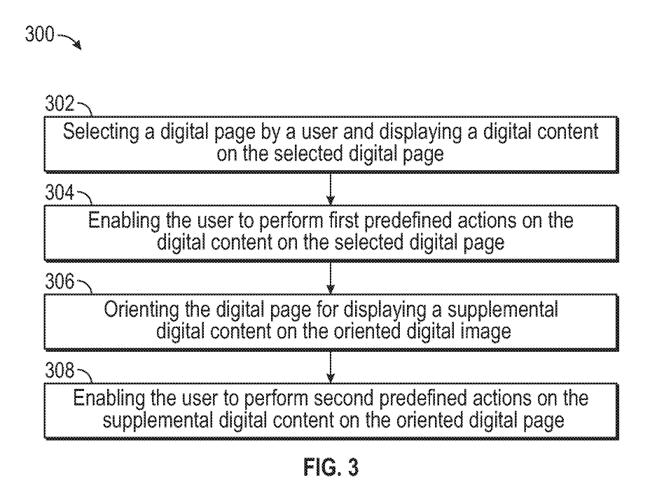

Referring to FIG. 3, FIG. 3 is a flow diagram 300 depicting method for accessing content of digital pages, in accordance with one or more embodiments. Method 300 may be carried out in the context of the details of FIG. 1, and FIG. 2. However, method 300 may also be carried out in any desired environment. Further, the aforementioned definitions may equally apply to the description below.

The method commences at step 302, select the digital page in the computing device by the user and display a digital content on the selected digital page. At step 304, enable the user to perform the first predefined actions on the digital content on the selected digital page. Thereafter, at step 306, orient the digital page in the computing device for displaying a supplemental digital content on the oriented digital image. Thereafter, at step 308, enable the user to perform the second predefined actions on the supplemental digital content on the oriented digital page. Here, the second predefined actions comprising: following the supplemental digital content, unfollowing the supplemental digital content, and enabling the user to perform a purchasing activity of a product associated with the supplemental digital content.

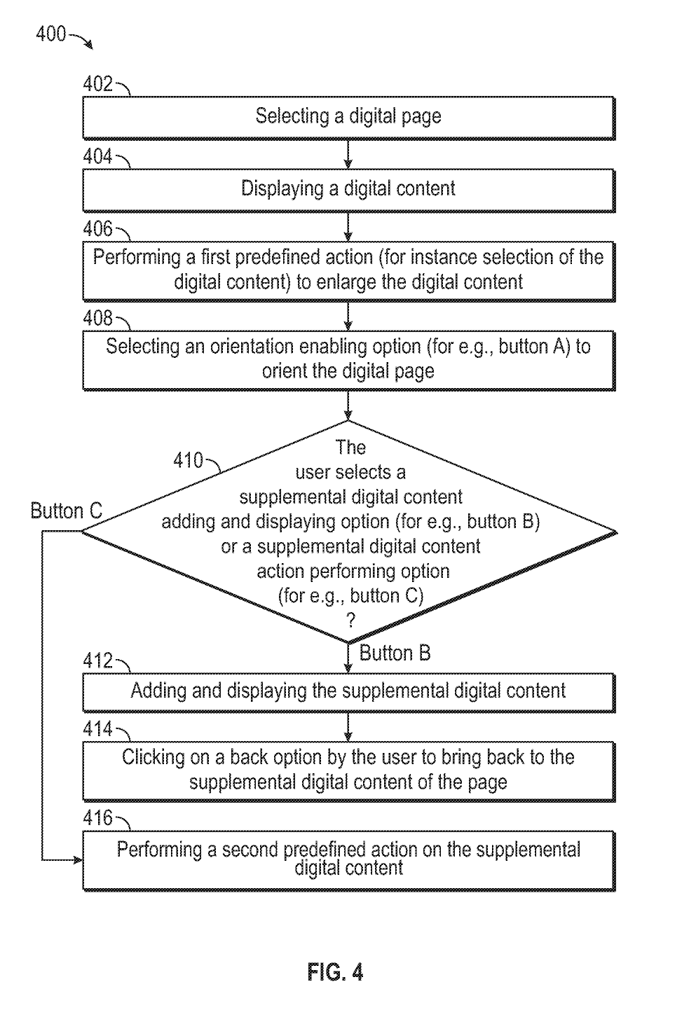

Referring to FIG. 4, FIG. 4 is a flow diagram 400 depicting the method of orienting digital pages to incorporate a supplemental digital content, in accordance with one or more embodiments. Method 400 may be carried out in the context of the details of FIG. 1, FIG. 2, and FIG. 3. However, method 400 may also be carried out in any desired environment. Further, the aforementioned definitions may equally apply to the description below.

The method commences at step 402 by selecting the digital page. Once the digital page is selected, the digital content may be displayed, at step 404. The first predefined action (for instance selection of the digital content) may be performed on the digital page to enlarge the digital content, at step 406. Once the digital content is enlarged, an orientation enabling option (for e.g., button A) may be selected by the user to orient the digital page, at step 408. Once the digital page is oriented, the user may select a supplemental digital content adding and displaying option (for e.g., button B) or a supplemental digital content action performing option (for e.g., button C), at step 410. If the selected option is supplemental digital content adding and displaying option (for e.g., button B), it indicates adding and displaying the supplemental digital content, at step 412. Here, the user may view digital page details, followers of digital page and other content of the digital page. If the user clicks on the back option, it brings back to the supplemental digital content of the page, at step 414. If the selected option is supplemental digital content action performing option (for e.g., button C), it indicates the performed second predefined action (for e.g., unfollowing the supplemental digital content), i.e., the supplemental digital content is not displayed on the oriented digital page, at step 416.

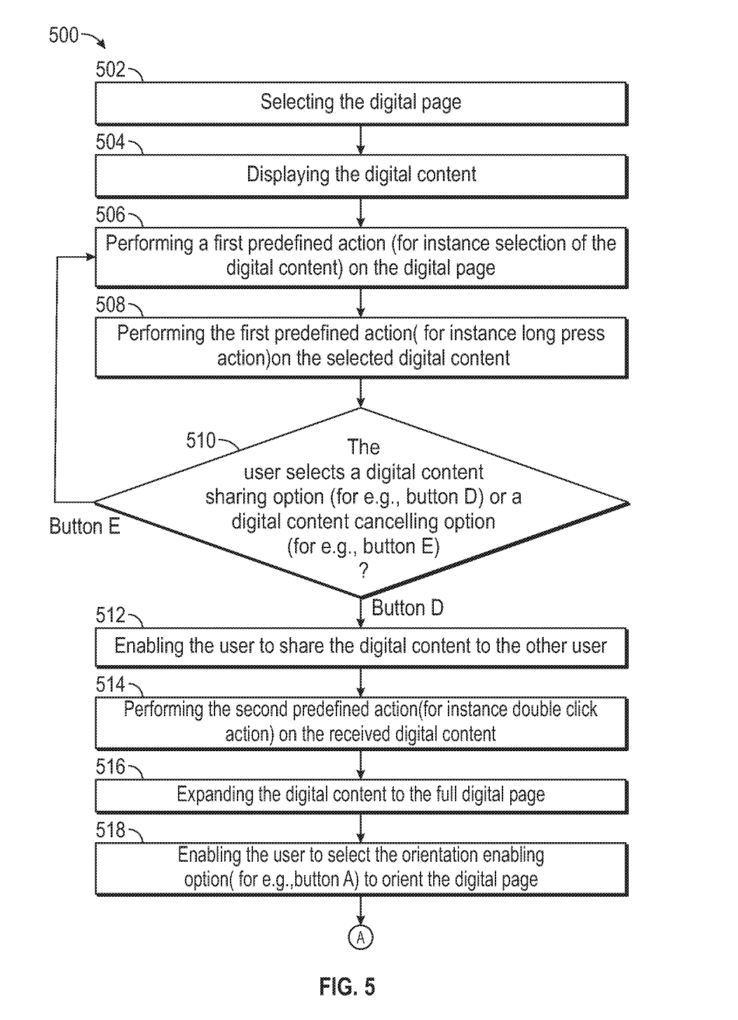

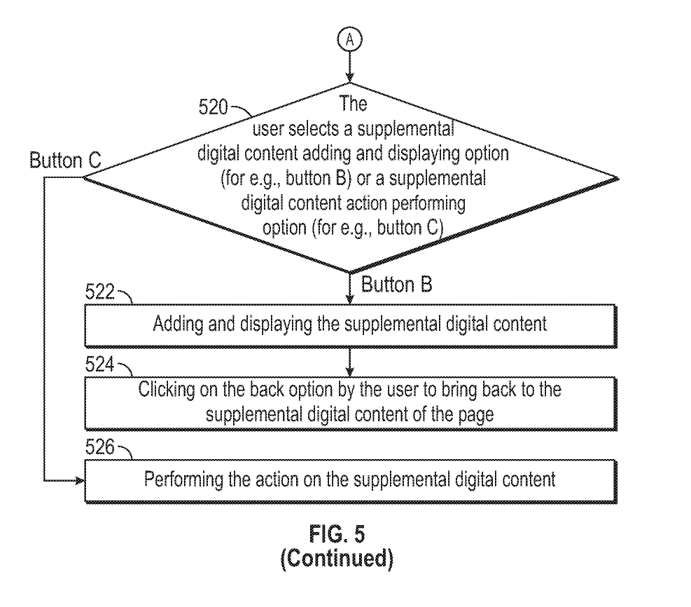

Referring to FIG. 5, FIG. 5 is a flow diagram 500 depicting method for sharing digital content to other users, in accordance with one or more embodiments. Method 500 may be carried out in the context of the details of FIG. 1, FIG. 2, FIG. 3, and FIG.4. However, method 500 may also be carried out in any desired environment. Further, the aforementioned definitions may equally apply to the description below.

The method commences at step 502 by selecting the digital page. Once the digital page is selected, the digital content may be displayed, at step 504. The first predefined action (for instance selection of the digital content) may be performed on the digital page, at step 506. The first predefined action (for instance long press action) may be performed on the selected digital content, at step 508. Once the long press action is performed, the user may select a digital content sharing option (for e.g., button D) or a digital content cancelling option (for e.g., button E), at step 510. If the user selected option is digital content cancelling option (for e.g., button E), then the method continues at step 506. If the user selected option is digital content sharing option (for e.g., button D), then at step 512, the user may be enabled to share the digital content to the other user. Once the digital content is shared, the other user may be allowed to perform the first predefined action (for instance double click action) on the received digital content, at step 514. Once the first predefined action (for instance the double click action) is performed, the digital content may get expanded to full digital page, at step 516. Once the digital content is expanded, the other user may be enabled to select the orientation enabling option (for e.g., button A) to orient the digital page, at step 518. Once the digital page is oriented, the user may select a supplemental digital content adding and displaying option (for e.g., button B) or a supplemental digital content action performing option (for e.g., button C), at step 520. If the user selected option is digital content adding and displaying option (for e.g., button B), it indicates adding and displaying the supplemental digital content, at step 522. Here, the user may view digital page details, followers of digital page and other content of the digital page. If the user clicks on the back option, it brings back to the supplemental digital content of the page, at step 524. If the user selected option is supplemental digital content action performing option (for e.g., button C), it indicates performed second predefined action (for e.g., following the supplemental digital content, i.e., the supplemental digital content is displayed on the oriented digital page), at step 526.

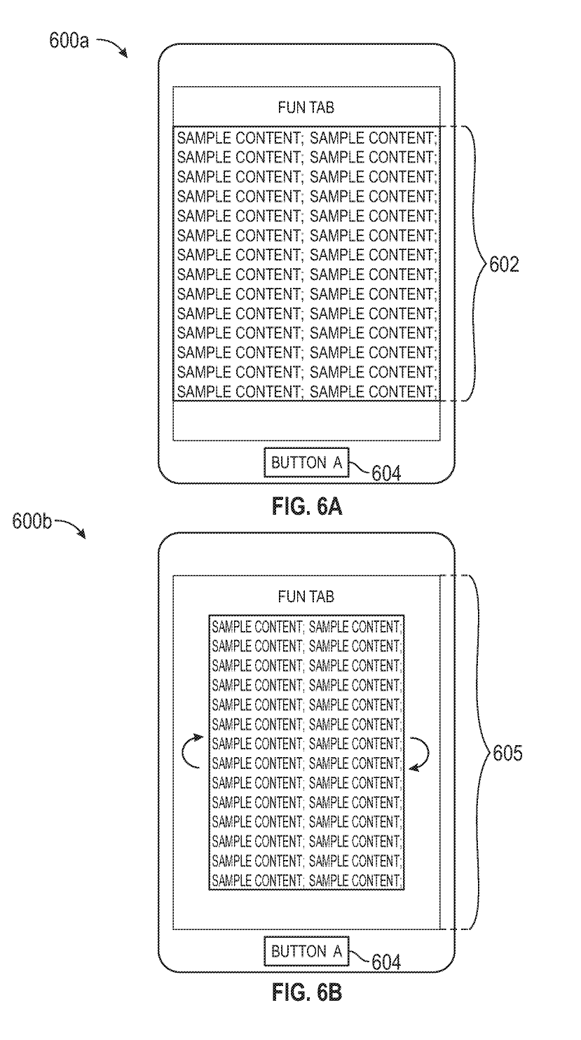

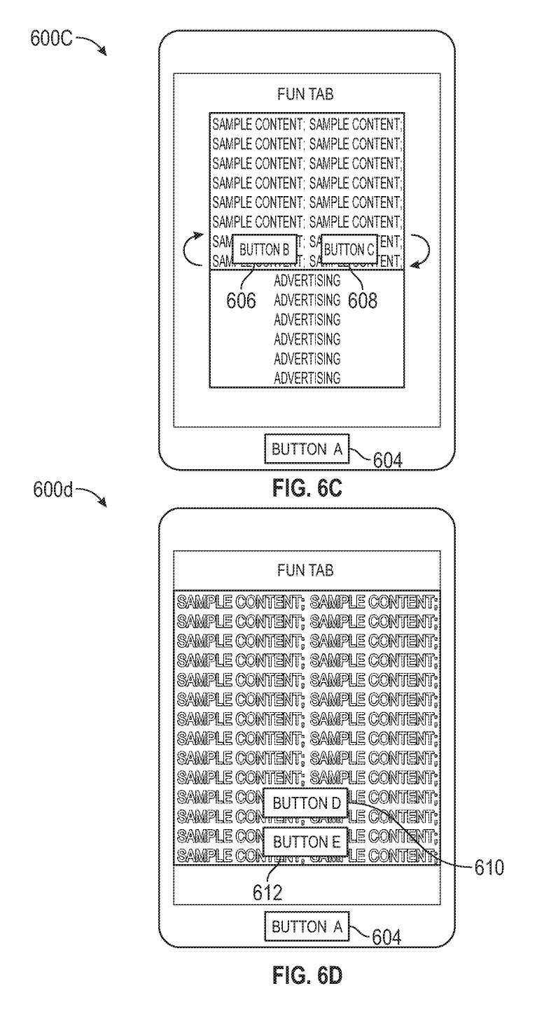

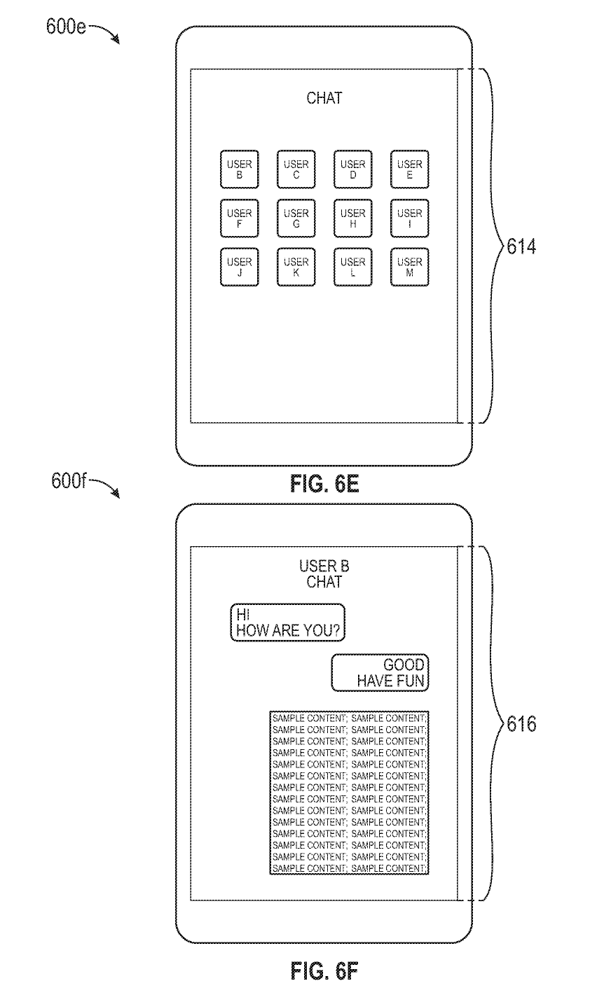

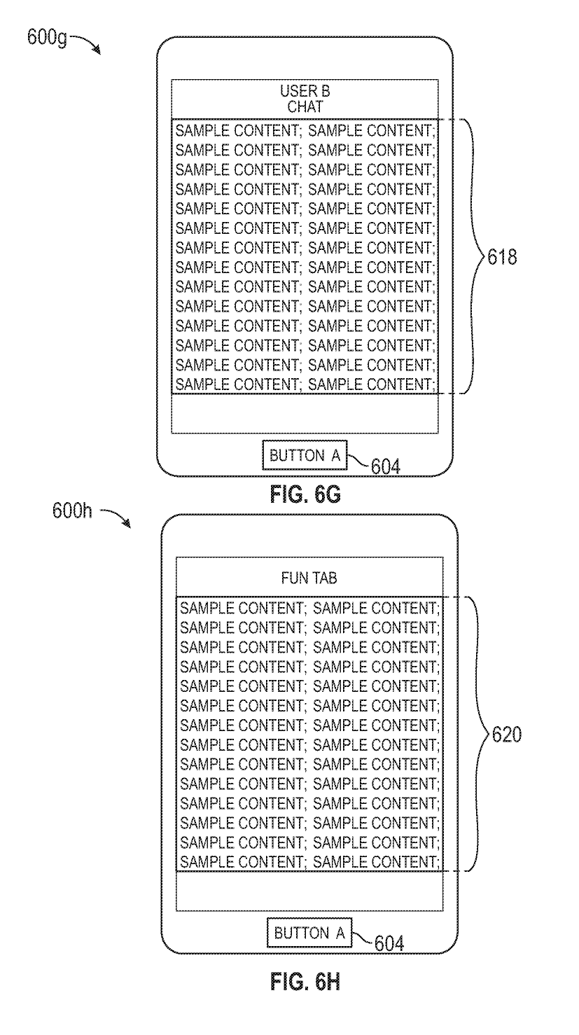

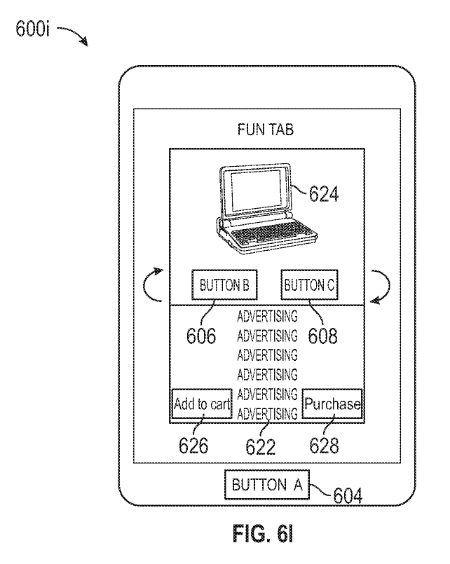

Referring to FIG. 6A, FIG. 6A is an example diagram 600a depicting a digital content on the digital page, in accordance with one or more exemplary embodiments. The diagram 600a includes a digital content 602, button A 604. The digital content 602 may be allowed to enlarge for viewing on the digital page. The button A 604 may be configured for enabling the user (for e.g., user A) to orient the digital page.

Referring to FIG. 6B-FIG. 6C, FIG. 6B-FIG. 6C are example diagrams 600b-600c depicting motion of digital pages, in accordance with one or more exemplary embodiments. The diagram 600b may depict the motion of digital page 605 after clicking on the button A 604. Once the digital page is oriented, button B 606 and a button C 608 may be displayed. If the user (for e.g., user A) clicks the button B 606, the supplemental digital content may be displayed for viewing. If the user (for e.g., user A) clicks the button C 608, the user may be allowed to perform the second predefined action on the digital page (for e.g., unfollow the digital page), i.e., not to display the supplemental digital content.

Referring to FIG. 6D, FIG. 6D is an example diagram 600d depicting a share option on the digital page, in accordance with one or more exemplary embodiments. If the user (for e.g., user A) performs a long press on the digital content 602, button D 610 and a button E 612 may be appeared. The button D 610 enables the user (for e.g., user A) to share the digital content to the other user. The button E 612 enables the user A to cancel sharing the digital content.

Referring to FIG. 6E, FIG. 6E is an example diagram 600e depicting number of users in the digital page, in accordance with one or more exemplary embodiments. The diagram 600e may depict number of users 614 (for e.g., user B, user C, user D, user E, user F, user G, user H, user I, user J, user K, user L, user M, and the like). If the user A clicks button D 610, then the user A may be allowed to invoke real time conversation with other users 614. The user A may also be enabled to share the digital content with the preferred users from the other users 614.

Referring to FIG. 6F-6G, FIG. 6F-6G are example diagrams 600f-600g depicting a real time conversation, in accordance with one or more exemplary embodiments. The diagram 600f may depict real time conversation 616 of User A with the user B. If the user B performs the first predefined action (for e.g., double press action) on the selected digital content in the real time conversation 616, the selected digital content may be enlarged 618.

Referring FIG. 6H-6I, FIG. 6H-6I are example diagrams 600h-600i depicting the digital content and the supplemental digital content, in accordance with one or more exemplary embodiments. The diagram 600h depicts the digital content 620, and the button A 604. The digital content 620 may include, but is not limited to, animated images, text, and the like. If the user clicks the button A 604, then the diagram 600i depicts the supplemental digital content. The supplemental digital content comprising an advertising data 622 and an advertisement product 624. The advertising data and the advertisement product 624 may include, but is not limited to, an audio advertisement, a video advertisement, animated images, a text advertisement, and the like. The diagram 600i further depicts a add to cart option 626, and a purchase option 628. If the user selects the add to cart option 626, then it allows all selected products and associated quantity indications are added to a shopping cart. If the user selects the purchase option 628, then it allows purchase actions for the selected products. The purchase actions may include, but are not limited to, buying products, and selling products.

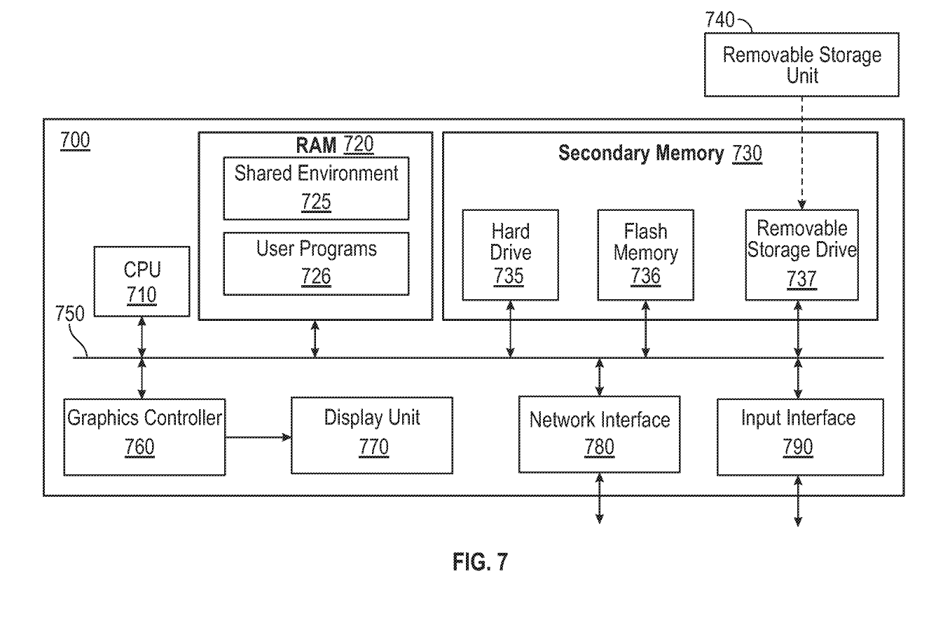

Referring to FIG. 7, Referring to FIG. 7, FIG. 7 is a block diagram depicting the details of digital processing system 700 in which various aspects of the present disclosure are operative by execution of appropriate software instructions. Digital processing system 700 may correspond to the computing device 104 (or any other system in which the various features disclosed above can be implemented).

The end-user's device 104 may contain one or more processors such as a central processing unit (CPU) 710, random access memory (RAM) 720, secondary memory 727, graphics controller 760, display unit 770, network interface 780, an input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, and/or data such as those used in threads and stacks, constituting shared environment 725 and/or user programs 726. Shared environment 725 includes operating systems, device drivers, virtual machines, etc., which provide a (common) run time environment for execution of user programs 726. The RAM 720 may also be configured to store the modules of the digital content accessing system 102.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on the removable storage unit 740, and the data and instructions may be read and provided by removable storage drive 737 to CPU 710. Floppy drive, magnetic tape drive, CD-ROM drive, DVD Drive, Flash memory, a removable memory chip (PCMCIA Card, EEPROM) are examples of such removable storage drive 737.

The removable storage unit 740 may be implemented using medium and storage format compatible with removable storage drive 737 such that removable storage drive 737 can read the data and instructions. Thus, the removable storage unit 740 includes a computer-readable (storage) medium having stored therein computer software and/or data. However, the computer (or machine, in general) readable medium can be in other forms (e.g., non-removable, random access, etc.).

In this document, the term “computer program product” is used to generally refer to the removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub combinations of the various features described herein above as well as variations and modifications thereof, which would occur to persons skilled in the art upon reading the foregoing description.

1. A computer implemented method for accessing content of digital pages, comprising:
selecting a digital page by a user and displaying a digital content on the selected digital page, whereby the user enabled to perform a first plurality of predefined actions on the digital content on the selected digital page; and
orienting the digital page for displaying a supplemental digital content on the oriented digital image, whereby the user enabled to perform a second plurality of predefined actions on the supplemental digital content on the oriented digital page.

2. The computer implemented method of claim 1, further comprising a step of expanding the digital content to the full digital page.

3. The computer implemented method of claim 1, further comprising a step of enlarging the digital content on the digital page.

4. The computer implemented method of claim 1, further comprising a step of selecting a plurality of first action buttons to perform the first plurality of predefined actions on the digital content on the oriented digital page.

5. The computer implemented method of claim 1, further comprising a step of selecting an orientation enabling option by the user to orient the digital page.

6. The computer implemented method of claim 1, further comprising a step of selecting a supplemental digital content adding and displaying option to add and display the supplemental digital content on the oriented digital page.

7. The computer implemented method of claim 1, further comprising a step of expanding the supplemental digital content to the full oriented digital page.

8. The computer implemented method of claim 1, further comprising a step of selecting a plurality of second action buttons to perform the second plurality of predefined actions on the supplemental digital content on the oriented digital page.

9. The computer implemented method of claim 1, further comprising a step of enabling the user to share the digital content and the supplemental digital content.

10. A digital content accessing system for accessing content of digital pages, comprising:
a computing device configured to allow a user to select a plurality of digital pages and display a digital content on the plurality of digital pages, whereby the user enabled to perform a first plurality of predefined actions on the digital content and the plurality of digital pages are oriented in the computing device; and
a supplemental digital content displayed on a plurality of oriented digital pages in the computing device, whereby the user enabled to perform a second plurality of predefined actions on the supplemental digital content on the plurality of oriented digital pages.

11. The digital content accessing system of claim 10, further comprising at least one digital content displaying module configured to display the digital content on the selected plurality of digital pages.

12. The digital content accessing system of claim 10, further comprising at least one digital content action performing module configured to enable the user to perform the first plurality of predefined actions on the digital content on the digital pages.

13. The digital content accessing system of claim 12, wherein the first plurality of predefined actions comprising a selection of the digital content, long press action, and a double click action.

14. The digital content accessing system of claim 10, further comprising at least one digital page orientation module configured to orient the plurality of digital pages.

15. The digital content accessing system of claim 10, further comprising at least one supplemental digital content displaying module configured to display the supplemental digital content and at least one supplemental digital content adding module configured to add the supplemental digital content on the plurality of oriented digital pages.

16. The digital content accessing system of claim 10, further comprising at least one supplemental digital content action performing module configured to perform the plurality of predefined actions on the supplemental digital content on the plurality of oriented digital pages.

17. The digital content accessing system of claim 10, wherein the second plurality of predefined actions comprising: follow the supplemental digital content, unfollow the supplemental digital content, and enable the user to perform a purchasing activity of a product associated with the supplemental digital content.

18. The digital content accessing system of claim 10, further comprising at least one digital content sharing module configured to share the digital content and the supplemental digital content.

19. The digital content accessing system of claim 10, further comprising a database configured to store the digital content and the supplemental digital content.

20. A computer program product comprising module code embedded in a non-transitory data storage medium, wherein execution of the module code on an a computing device causes the computing device to:
select a digital page by a user and displaying a digital content on the selected digital page, whereby the user enabled to perform a first plurality of predefined actions on the digital content on the selected digital page; and
orient the digital page for displaying a supplemental digital content on the oriented digital image, whereby the user enabled to perform a second plurality of predefined actions on the supplemental digital content on the oriented digital page.
